(19) United States
(12) Patent Application Publication
(10) Pub. No.: US 2022/0179405 A1
(43) Pub. Date: Jun. 9, 2022

(54) Simulation Device and Method for Virtually Testing a System Control Process

(71) Applicant: Siemens Aktiengesellschaft, Muenchen (DE)

(72) Inventor: Benjamin LUTZ, Pfinztal (DE)

(21) Appl. No.: 17/442,860

(22) PCT Filed: Mar. 16, 2020
(86) PCT No.: PCT/EP2020/057038

§ 371 Date: Sep. 24, 2021

(30) Foreign Application Priority Data
Mar. 27, 2019 (EP) 19165585

(51) Int. Cl. G05B 19/418

(52) U.S. Cl. CPC G05B 19/41885; G05B 19/4188; G05B 19/41845

(57) ABSTRACT

A method for virtually testing a system control process for a process engineering system and a simulation device for virtually testing the system control process, wherein at least one preconfigured control module for controlling a component of the system is provided and the system control process is generated based on this control module and the control of the process engineering system is additionally simulated by the generated system control process, where at least one value of an input parameter of the system control process is predefined by a component-specific simulation model, and where the component-specific simulation model is contained in the preconfigured control module.

### CROSS-REFERENCE TO RELATED APPLICATIONS

This is a U.S. national stage of application No. PCT/EP2020/057038 filed 16 Mar. 2020. Priority is claimed on European Application No. 19165585.1 filed 27 Mar. 2019, the content of which is incorporated herein by reference in its entirety.

### BACKGROUND OF THE INVENTION

### 1. Field of the Invention

The present invention relates to a method for virtually testing a system control for a process engineering system and to a simulation device for virtually testing such a system control.

### 2. Description of the Related Art

Process engineering systems, such as refineries or factories, in which materials are altered with respect to their composition, type or characteristic can have extremely complex structures. A system can comprise, for example, of a large number of components, optionally interconnected and/or independent of each other, such as valves, sensors, and/or actuators. As a rule, such systems are managed by specific, in particular computer-based or at least computer-assisted, process control systems, which can consider, in particular, the process engineering-related connections between the various components. Such process control systems comprise automation technology, in particular automation programs and operating and monitoring programs.

Process control systems of this kind, also referred to as a system control, are frequently developed based on individual modules, which are each assigned to an individual component of the system and are adapted for controlling this component. A module of this kind can be understood as a standardized model of the control software for one type of component, with the module having to be accordingly adjusted to the specific characteristic of the component when assembling the process control system or system control to enable correct management of the component and therewith of the entire system as well.

Before they are used, system controls developed from individual modules are usually tested in a real system via simulation to ensure or optionally improve the functionality of the control. For this, it is conventionally necessary to provide a set of input variables for the system control to be tested, by way of which, for example, the test is activated. In general, the process engineering system is simulated for this purpose and managed by the system control to be tested. This procedure is also referred to as emulation of the system control.

The simulation of the system can be assisted by what are known as simulation models, which generate the input variables. The simulation models, similarly to the individual control modules for controlling the system components, must be adjusted to the specific characteristics of the components or to their specific function and/or arrangement in the system and, more precisely, in particular by considering the control logic implemented by the system control.

### SUMMARY OF THE INVENTION

It is an object of the present invention to improve, in particular to simplify, testing of a system control of a processing engineering system.

This and other objects and advantages are achieved by a method for virtually testing a system control for a process engineering system and a simulation device for virtually testing such a system control.

In accordance with a first aspect of the invention, a method, in particular a computer-implemented one, for virtually testing a system control for a process engineering system comprises: (i) providing at least one preconfigured control module for controlling a component of the system, (ii) generating the system control based on this provided control module, and (iii) simulating the control of the process engineering system via the generated system control, where at least one value of an input parameter of the system control is predefined by a component-specific simulation model. Here, the component-specific simulation model is contained in the pre-configured control module.

In accordance with a second aspect of the invention, a simulation device for virtually testing a system control for a process engineering system is configured to implement the method in accordance with the first aspect of the invention.

One aspect of the invention is based on the approach of combining control modules, for example, in the form of modular control software, which serve to control one component in each case of a process engineering system, and simulation models, on the basis of which these components can be simulated. In particular, a simulation model for simulation of a system component can be integrated in a control module for controlling this system component. As a result, a simulation model required for overall simulation of the system can already be provided by providing the control module of the corresponding component, in other words, can be made directly accessible, for example. Preferably, the configuration of the control module is assumed by the simulation model, in other words the simulation contained in the control module can already be adjusted, for example, in the same manner as the control module, to a specific characteristic of a component of the system. As a result, an additional manual, possibly complex, adjustment of the simulation model to the structure of the system and/or the system control at a subsequent point in time, for instance, immediately before performing the simulation, can be omitted.

For example, in a planning phase in which the processing engineering system or its structure are basically designed, for example, the required components are assembled, the component types and optionally also specific properties of these types already can be defined and the corresponding control module can be pre-configured by considering the component type or the properties. It is conceivable, for example, to allow for a number of valves, optionally even of specific valve types, and to configure appropriate control modules. The simulation models of these valves or valve types are preferably contained in the control modules. Consequently, there is a clear assignment of the simulation models to these valves or valve types, in particular to their function and arrangement in the processing engineering system. This can facilitate an adjustment of the control modules.

During testing of the system control the simulation models can be used directly, in particular without further adjustments, in order to supply values for input parameters of the system control, in particular the individual control modules, of which the system control is comprised.

In principle, these component-specific simulation models can be inventively pre-configured based on the control modules as early as before creating the system control. However, it is also conceivable to perform an adjustment of the component-specific simulation models in a development phase when creating the system control as well, for example, when assembling the system control from the control modules, it being possible, for example, to consider the arrangement of the components of the system. In other words, it is possible in this way to consider the logic behind the system control in the simulation models early on already.

This can be advantageous, for example, because the process engineering-related connection between the components of the system, in particular between the corresponding control modules, is also known or worked out in the planning and/or development phase and can thus be considered when pre-configuring the corresponding simulation models.

The integration of a simulation model into a control module of the same component can also have the advantage that values, predefined by the simulation model, for input parameters of the control module or the system control can be generated, in particular calculated, within the control module itself, in other words confidentially. It is thereby possible to simplify signal paths or structures for data transfer within the simulation and to at least reduce the error rate.

Unless explicitly ruled out or technically impossible, the features described below in connection with preferred embodiments of the invention can be randomly combined with each other.

In a preferred embodiment, at least one value predefined within the control module by a component-specific simulation model induces the at least one control module that has been provided to simulated control of the component of the system. The predefined value for an input parameter of the system control or the control module is preferably an internal value, which is preferably processed only within the control module. As a result, during the simulation the control module is capable of operating by way of self-referencing, and this reduces the outlay on the generation of the simulation, managed by the system control, for testing the system control.

The component-specific simulation model can provide, in particular, an internal value as a signal that can be incorporated by a control module in order to stimulate it, in other words, for example, to induce it to control the component. The component-specific simulation model is preferably adapted to predefine, in particular to calculate and then output, values, which lie within a value range that can be processed by a control module and, for example, characterize a manipulated variable, which is to be regulated by the system control assembled from the at least one preconfigured control module. As a result, control of the system by the generated system control can be reliably and faultlessly simulated.

For this purpose, the control module can have an internal interface provided by the simulation model, via which the simulation model communicates with the control module, in other words data, for example, the at least one value of an input parameter of the system control, can be transmitted or transferred. For example, based on the internal interface of a valve model, a manipulated variable of the valve, which characterizes, for example, the degree of opening of the valve, can be provided in a format, which the control module can process when generating a control signal for simulated control of the valve.

In a further preferred embodiment, the behavior of the component of the system is mapped by at least one value predefined within the control module by the component-specific simulation model. For this purpose, the simulation model contained in the control module can be adapted to provide at least one value based on the behavior of the system component, in particular with regard to the overall structure of the system. This enables precise simulation of control of the system.

For example, the simulation model can contain a description of the behavior of the system component to be simulated, with the description of the behavior preferably mapping the physical functionality of the component, in other words, for example, the limitation of the flow rate of a fluid through a valve. The functionality can also depend on parameters, which are not predefined by the component itself but by its surroundings in the processing engineering system or even the operating state of the system. For example, the possible limitation of the flow rate of a fluid through a valve can be predefined not only by the design of the valve, in particular the valve type, but also by parameters such as the density of the fluid, and/or the fluid pressure. Within the control module, the simulation model can thus provide particularly extensive and/or realistic values as the input parameters for the control module.

It is conceivable, for example, that the simulation model, such as for an actuator, contains a model, such as a controlled system, which is preferably mapped by a mathematical equation. In this case, for example, the actuator is preferably to be regulated on this controlled system by the control module or the system control, in other words, the control module can contain information in respect of the controlled system, such as via corresponding pre-configuration. Due to the integration of the simulation model in the control module, the simulation model does not have to be additionally adjusted in relation to the controlled system.

In a further preferred embodiment, at least one value predefined within the control module by the component-specific simulation model depends on a further component of the system, in particular on the control module thereof. In particular, the simulation model can be adapted to provide the predefined value by considering a further system component. As a result, the process engineering-related connection, in whose framework, for example, neighborhood relations of the component to a further, different component are described, can be considered. Preferably, the control of the further component, in particular in the form of the control logic implemented by the control module thereof, can be considered.

For example, the simulation model of a controller, by which an actuator is actuated, can be adjusted to the control or the control module of the actuator, in particular during the configuration of the control module. Preferably, the simulation model of the controller contains information in respect of parameters of the control module of the actuator or at least has access thereto. The controller can be simulated in a form specifically adjusted to the motor, therefore.

Consideration of further components, in particular of parameters or signals of the corresponding control module, allows, in particular, values to be provided on the basis of the simulation model not only for input parameters of the corresponding individual control module but for the entire system control.

In a further preferred embodiment, at least one value is predefined within the control module by the component-specific simulation model on the basis of a parameter of the at least one control module that has been provided. The simulation model can be integrated, in particular, in the control module such that the simulation model has direct access to parameters of the control module. For example, the simulation model can be adapted to consider as parameters the factors of a control module, for example, the prefactors of terms of a PID control or the like from the control module. As a result, the at least one predefined value can be reliably processed by the control module or be used for control of the component.

In a further preferred embodiment, at least one value is predefined within the control module by the component-specific simulation model based on an output variable, which the at least one control module that has been provided outputs for controlling the component. The value can be predefined, in particular, on the basis of a signal for controlling the component, which the control module generates. As a result, a control module-internal feedback is generated in the system control, on the basis of which the behavior of the system control can be tested.

For example, the simulation model can be adapted to incorporate manipulated variables of a component, such as a valve, which are output by the control module as a signal to the simulation component, such as the valve, and to process them for simulation of a reaction of the component, such as the valve. Preferably, the manipulated variables or other output variables are read directly from the control module, whereby the efficiency of the simulation, and therewith of testing of the system control, can be increased. The output variables can be transferred, in particular, via an internal interface of the control module, provided by the simulation model, from the control module to the simulation model.

In a further preferred embodiment, at least one output value of a mathematical function is predefined as the value by the component-specific simulation model. The mathematical function is preferably adapted to describe the component or its behavior. The use of a mathematical function simplifies the integration of the simulation model in the control module or allows a particularly straightforward and fast adjustment of the simulation model within the control module. For this purpose, the function can be linked, for example, to the control module, such as to parameters of the control module.

The mathematical function can combine, in particular, different aspects of the component to be simulated and/or of the control module or relate them to one another, for instance, in the form of a plurality of terms or variables. For example, the mathematical function can incorporate as an input variable parameters of the control module such as proportional-integral-derivative (PID) constants, output variables of the control module, such as a manipulated value of the component and/or parameters or output variables of control modules of components of the system, which are adjacent in terms of process engineering, and optionally relate them to each other so as to simulate extensive and realistic behavior of the component within the control module.

In a further preferred embodiment, the method further includes adjusting the component-specific simulation model contained in the control module to physical properties of the component of the system. For example, it is conceivable that specific demands on the components can already be foreseen in a planning phase, in which the physical structure of the process engineering system is planned and the individual components required for this are assembled. Alternatively or in addition, such demands can also be ascertained in the framework of a development phase in which the wiring or logic of the components is developed based on their arrangement and/or function in the system. The adjustment of the simulation model to the physical properties that accompany the demands is preferably performed as early as in the planning phase and/or development phase, i.e., before the completion of the system control. As a result, it is possible to test the system control that is completely developed based on control modules with the help of an overall model of the system comprising simulation models, which are already-specialized, of the individual components without the simulation models having to be painstakingly adjusted manually afterwards.

In a further preferred embodiment, the method further comprises pre-configuring the at least one control module, where the component-specific simulation model contained in the control module is preferably adjusted to the pre-configuration. As a result, a coherence between control module and simulation model can be maintained or errors due to control module and simulation models not being matched to each other can be prevented or at least reduced.

For example, within the framework of the development phase, a control module can be adjusted in view of the interaction of the component with at least one further, different component such that, for example, a damping element is introduced into the control logic. In response thereto, a damping, for instance in the form of a damping term in a mathematical function, can be inserted directly into the simulation model.

In a further preferred embodiment, one of a plurality of variants of the pre-configured control module is provided. Preferably, the component-specific simulation model contained in the control module is adjusted to the provided variant. For instance, a valve type can be pre-configured, for example, a control valve, which is used multiple times in accordance with a planning process of the system. As a function of the arrangement of these valves it is conceivable, however, that different variants with respect to the travel of the valve will be required, so appropriately configured variants of a control module can be provided for a control valve. Each of these control module variants already contains a component-specific simulation model. Accordingly, it is particularly easy to also adjust the simulation models to the different travel distances. In particular, the risk of confusion, for example, which of the valves has which travel and is controlled by which control module, can be reduced.

In a further preferred embodiment, the component-specific simulation model is automatically adjusted. The simulation model can be adjusted, in particular automatically, via an adjustment or a pre-configuration of the control module, for example, to a desired effect of the component in the system. As a result, testing of the system control can be simplified considerably and be efficiently performed.

For example, the simulation model, such as in the form of a mathematical function, can depend on parameters on which an output variable generated by the control module, for example, a control signal, also depends. Once these parameters have been adjusted during pre-configuring of the control module, this adjustment can also be automatically transferred to the simulation model integrated in the control module without a further adjustment having to be made.

In a further preferred embodiment, the at least one pre-configured control module is provided in a generic format in which the component-specific simulation model can be read from the at least one control module that has been provided and can be used by a system simulator for generation of at least one value for a parameter of the simulation model. The generic format can be, for example, a file format and/or data structure, which is accessible by a system simulator, for instance, simulation software. Provision of the control modules and the readability of the simulation models contained therein can make it easier to generate an overall simulation comprising a plurality of simulation models that have already been configured and to use them for testing the system control.

The above-described properties, features and advantages of the first aspect of the invention also apply, where technically expedient, to the second aspect of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail below with reference to figures. In the drawings, at least partially schematically:

FIG. 1 shows an exemplary flowchart of a method for testing a system control for a process engineering system in accordance with the invention; and

FIG. 2 shows an an exemplary control module for controlling a component of a system with a simulation model of the component in accordance with the invention.

### DETAILED DESCRIPTION OF THE EXEMPLARY EMBODIMENTS

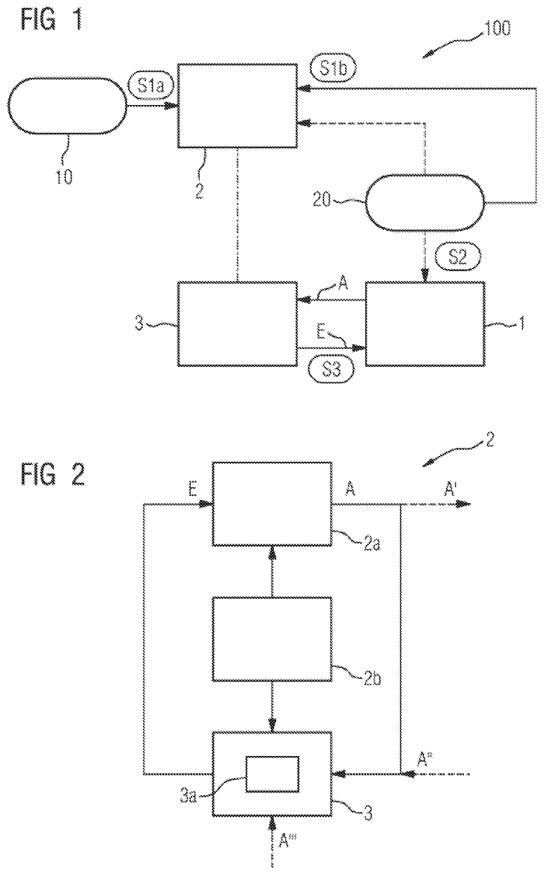

FIG. 1 shows an example of a method 100, in particular an at least partially computer-implemented one, for virtually testing a system control 1 for a process engineering system, for instance a refinery or factory. The system control 1 is assembled at least partially from pre-configured control modules 2, which are each adapted to control a component of the system, such as a valve, an actuator, and/or a sensor, and can be provided, as required, in different phases of the development process of a processing engineering system, in particular a planning phase 10 for design of the process engineering system and/or a development phase 20 for creating the system control 1. The control modules 2 contain simulation models 13 of the component of the system, based on which the control of the system by the system control 1 can be simulated.

The pre-configured control modules 2, such as modular, component-specific control software units, which each contain the control software for one component of the system, are provided in a method step S1a, S1b. Different types of components, which the system should comprise, can be defined and, such as their properties established, in the planning and/or development phase 20, optionally in a preceding method step (not shown). During provision S1a, S1b of the control modules 2 preferably different variants of these pre-configured control modules 2 are then each provided which, owing to their slightly differing configurations, can fulfil specific functions, such as according to the arrangement of the components within the system. This provision S1a, S1b of different variants of a generic control module 2 can also be referred to as instantiation.

In a further method step S2, the control modules 2 are assembled to form the system control 1. This preferably occurs in the development phase 20. The control modules 2 can be specified further, for example be adjusted to demands and/or dependencies of different components of the system on each other, resulting during creation of the system control 1. In particular, if necessary, further control modules 2 can also be instantiated.

The system control 1 generated in this way can then be tested based on a virtual model of the system, in other words, within the framework of a simulation. The simulation is preferably performed based on the simulation models 3 of the components of the system, with an overall model of the system being at least partially assembled from the individual simulation models 3. Control of the system via the previously generated system control 1 is simulated in a further method step S3, where it is possible for the implementation of the system control 1 based on the simulated system model, assembled at least partially from the simulation models 3, to also be referred to as emulation.

Values for input parameters E of the system control 1 are required for emulation of the system control 1. For example, measured values of a sensor are required for pressure measurement in order to be able to generate a control signal for controlling a valve as a function of the measured values, or the manipulated variable of a valve is required in order to be able to generate a control signal for an actuator as a function of the manipulated variable. Such values can be generated and provided in method step S3 based on the simulated overall model of the system or the simulation models 3 of the individual components of the system in order to be incorporated and processed by the system control 1. The control signals, generated by the system control, for the components of the system or other output variables A can likewise be provided in order to be incorporated by the simulation models 3 and for generating further values for the input parameters E of the system control 1. The feedback that can thus be generated corresponds precisely to the simulation S3 of the control of the processing engineering system by the system control 1.

Here, it is particularly advantageous to contain the simulation models 3 in the control modules 2, as is indicated by the dot-dash connecting line in FIG. 1. Because, as a result, the simulation models 3 can be pre-configured substantially at the same time as the control modules 2, in particular during the planning and/or development phase 10, 20. For example, it is conceivable to define the simulation models 3, together with the control modules 2, directly in the method step (not shown) directly before providing Sla, S1b of the control modules 2 and to optionally specify them analogously to the control modules 2 in accordance with the functionality and arrangement of the corresponding component in the system. This increases the efficiency of virtually testing the system control 1 because, with a subsequent configuring of the simulation models 3, in particular after the system control 1 has already been created in method step S2, the clarity can be impaired.

Alternatively or in addition, it is also conceivable to adjust the simulation models 3 during provision Sla, S1b of the pre-configured control modules 2, for example, to the respective control module 2 and/or to supplement aspects, which are established in the respective phase 10, 20, such as the process engineering-related connection between two components.

FIG. 2 shows an exemplary control module 2 for controlling a component of a process engineering system, where the control module 2 contains a simulation model 3 of the component. The control module 2 is preferably characterized by a control unit (processor) 2a, which implements the control logic, in other words, for example, processes values of input parameters E and on the basis thereof provides output variables A, such as control signals for controlling the component. The control unit 2a can include, in particular, software code, such as a script stored in memory of the control unit 2a. In a particularly preferred embodiment, the control unit 2a implements a Continuous Function Chart (CFC) with which even complex control tasks and/or feedback control problems can be mapped or implemented.

The control module 2 can also contain parameters 2b on the basis of which the, preferably generic, control logic of the control module 2, such as the continuous function chart, can be implemented. The parameters 2b can be, for instance, prefactors of a mathematical function, which maps the control logic and is implemented by the control unit 2a.

The control unit 2a can, for example, implement a proportional-integral-differential (PID) control, with three parameters 2b being used as prefactors of the proportional, integral and differential elements of the control.

While, as a rule, the control unit 2a is not adjusted in the framework of the development process of the system control but is generic for a particular type of component, such as a valve, the parameters 2b can be adjusted in the different phases of the development process, such as to the intended effect of the corresponding component within the system. Adjusting the parameters 2b can be part of a pre-configuring of the control module 2.

An output variable A, generated by the control unit 2a, such as in the form of a control signal, does not have to be used exclusively for controlling the component that is assigned to the control module 2. A different component can optionally also be controlled based on such control signals, in particular if it is connected to the component, to which the control module 2 is assigned, in terms of process engineering. It is conceivable, for example, that a control signal generated by a control unit 2a of the control module 2 of a controller is used for controlling an actuator. This is indicated by the broken-line arrow A′.

As indicated in FIG. 2, the values for input parameters E of the control unit 2a are preferably provided by the simulation model 3 within the control module 2. These can be, for example, (simulated) output signals of the component, for instance of a sensor, on the basis of which the control unit 2a can generate a control signal in the form of a value of the output variable A. Alternatively, the value of an input parameter E can also simply be a manipulated variable of the component, for example, of a valve, which is to be considered on generation of a control signal by the control unit 2a. In particular, the value of an input parameter E can characterize the (operating) state of the component.

In addition, the component, in particular within an overall simulation of the processing engineering system, can be simulated based on the simulation model 3. For this purpose, the simulation model 3 preferably has a simulation unit 3a, which maps the behavior of the component, in other words processes, for example, output variables A of a control unit 2a, such as in the form of control signals and on the basis thereof provides values of input parameters E. The simulation unit 3a can be formed, in particular, by software code, for example, as a script. In a particularly preferred embodiment, the simulation unit 3a comprises a mathematical function, which maps the behavior of the component. Alternatively or in addition, the simulation unit 3a can also comprise other forms of behavioral descriptions, however, such as continuous function charts.

In addition to the control signals, the behavior of the component can also be affected by external influences A″. These can be, for example, process conditions of the process performed by the process engineering system. The simulation unit 3a can thus consider, for example, which temperature and/or which pressure the component is exposed to and/or how high is the flow rate of a process fluid.

Optionally, the simulation unit 3a can also be adapted to consider the process engineering-related connection with further (simulated) components of the system. For example, control signals from a control module 2 of a controller can be considered in the case of simulation of an actuator. This is indicated by the broken-line arrow A′″.

Preferably, in addition to output variables A of the control unit 2a in the form of control signals, the simulation unit 3a also considers the parameters 2b of the control module 2 at least insofar as they are relevant to the simulation of the component. This can be the case, for example, if the component exhibits damped behavior and this damped behavior, which is characterized by a parameter 2b, is considered when controlling the component by incorporating this parameter 2b.

This embodiment shows particularly clearly the advantage of a control module 2 for controlling a component in which the simulation model 3 of the component is integrated. Because both control unit 2a and simulation unit 3a refer at least partially to the same parameter 2b, by adjusting the parameter, for instance, in the case of instantiation of control module 2 in the development phase, the simulation model 3 is also pre-configured at the same time as the control module 2. A separate, independent adjustment step of the simulation model, as is necessary in the prior art, can be omitted, such that the efficiency of the development process of the process engineering system, in particular of testing of the system control, is increased.

And even if adjustments of the simulation model 3 are necessary, which are not automatically implemented via a configuration of the control module 2 or the control unit 2a, for example, of a continuous function chart, the integration of the simulation model 3 in the control module 2 is advantageous in respect of the clarity of the development process of the system, in particular of testing of the system control. This is because as a result of the fact that when providing, for example, a variant of the pre-configured control module 2, a corresponding simulation model 2 is also automatically provided, firstly it is no longer necessary to subsequently ascertain how many simulation models have to be generated at all in order to make it possible to emulate the system control. Secondly, an easily comprehensible assignment of simulation model 3 to control module 2 is generated as a result.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A method for virtually testing a system control for a process engineering system, the method comprising:
providing at least one preconfigured control module which controls a component of the process engineering system;
generating the system control based on said at least one preconfigured control module; and
simulating the control of the process engineering system via the generated system control, at least one value of an input parameter of the system control being predefined by a component-specific simulation model;
wherein the component-specific simulation model is contained in the at least one preconfigured control module.

15. The method as claimed in claim 14, wherein at least one value predefined within the at least one preconfigured control module by the component-specific simulation model induces the provided at least one preconfigured control module to simulated control of the component of the process engineering system.

16. The method as claimed in claim 14, wherein behavior of the component of the process engineering system is mapped via at least one value predefined within the at least one preconfigured control module by the component-specific simulation model.

17. The method as claimed in claim 15, wherein behavior of the component of the process engineering system is mapped via at least one value predefined within the control module by the component-specific simulation model.

18. The method as claimed in claim 14, wherein the at least one value predefined within the at least one preconfigured control module by the component-specific simulation model depends on a further component of the process engineering system.

19. The method as claimed in claim 14, wherein at least one value is predefined within the provided at least one control module by the component-specific simulation model based on a parameter of the provided at least one preconfigured control module.

20. The method as claimed in claim 14, wherein at least one value is predefined within the provided at least one preconfigured control module by the component-specific simulation model based on an output variable, which the provided at least one preconfigured control module outputs for controlling the component.

21. The method as claimed in claim 14, wherein at least one output value of a mathematical function is predefined as the at least one value by the component-specific simulation model.

22. The method as claimed in claim 14, further comprising:
adjusting the component-specific simulation model contained in the at least one preconfigured control module to physical properties of the component of the process engineering system.

23. The method as claimed in claim 22, further comprising:
pre-configuring the at least one control module;
wherein the component-specific simulation model contained in the at least one preconfigured control module is adjusted to the pre-configuration.

24. The method as claimed in claim 22, wherein one of a plurality of variants of the at least one preconfigured control module is provided and the component-specific simulation model contained in the at least one preconfigured control module is adapted to the provided variant.

25. The method as claimed in claim 23, wherein one of a plurality of variants of the at least one preconfigured control module is provided and the component-specific simulation model contained in the at least one preconfigured control module is adapted to the provided variant.

26. The method as claimed in claim 22, wherein the component-specific simulation model is automatically adjusted.

27. The method as claimed in claim 23, wherein the component-specific simulation model is automatically adjusted.

28. The method as claimed in claim 24, wherein the component-specific simulation model is automatically adjusted.

29. The method as claimed in claim 14, wherein the at least one preconfigured control module is provided in a generic format in which the component-specific simulation model is readable from the provided at least one preconfigured control module that has been and utilizable by a system simulator for generation of at least one value for an input parameter E of the at least one preconfigured control module.

30. A simulation device for virtually testing a system control for a process engineering system, comprising:
a processor; and
memory;
wherein the simulation device is configured to:
providing at least one preconfigured control module which controls a component of the process engineering system;
generating the system control based on said at least one preconfigured control module; and
simulating the control of the process engineering system via the generated system control, at least one value of an input parameter of the system control being predefined by a component-specific simulation model;
wherein the component-specific simulation model is contained in the at least one preconfigured control module.
